(19) United States
(12) Patent Application Publication
(10) Pub. No.: US 2017/0064104 A1
(43) Pub. Date: Mar. 2, 2017

(54) IMAGE FORMATION APPARATUS, INFORMATION PROCESSING APPARATUS, AND INFORMATION PROCESSING SYSTEM

(71) Applicant: Oki Data Corporation, Tokyo (JP)

(72) Inventor: Keiko OISHI, Tokyo (JP)

(73) Assignee: Oki Data Corporation, Tokyo (JP)

(21) Appl. No.: 15/208,694

(22) Filed: Jul. 13, 2016

(30) Foreign Application Priority Data
Aug. 27, 2015 (JP) 2015-167492

(51) Int. Cl. H04N 1/00

(52) U.S. Cl. CPC H04N 1/00424; H04N 1/00411; H04N 2201/0094

(57) ABSTRACT

An image formation apparatus includes: a power supply unit that supplies power to the image formation apparatus; a display part; and a controller that controls a display on the display part. When the power supply unit is turned on, the controller switches the display on the display part to a first screen for user registration in a situation where the first screen is displayable, and switches the display on the display part to a home screen without switching to the first screen in a situation where the first screen is not displayable.

### CROSS REFERENCE TO RELATED APPLICATIONS

This application claims priority based on 35 USC 119 from prior Japanese Patent Application No. 2015-167492 filed on Aug. 27, 2015, entitled “IMAGE FORMATION APPARATUS, INFORMATION PROCESSING APPARATUS, AND INFORMATION PROCESSING SYSTEM”, the entire contents of which are incorporated herein by reference.

### BACKGROUND OF THE INVENTION

1. Field of the Invention

The disclosure relates to an image formation apparatus, an information processing apparatus communicatively connected to the image formation apparatus, and an information processing system including the image formation apparatus and the information processing apparatus.

2. Description of Related Art

There is proposed an image formation apparatus which is capable of communicating with a higher-level apparatus (information processing apparatus) and displays an operation screen on its operator panel (operation panel unit) according to a request command sent from the higher-level apparatus (see, for example, Japanese Patent Application Publication No. 2015-118437 (e.g., claims 1 and 2)).

### SUMMARY OF THE INVENTION

Nowadays, it is increasingly common for users to use image formation apparatuses while receiving various services from the manufacturer after the users register predetermined information (performs user registration) to an information processing apparatus through a website of the manufacturer. The predetermined information includes apparatus information, which is information about the image formation apparatus to be registered (user registration of the target apparatus), and user information, which is information identifying the user of the image formation apparatus. It is desired that such user registration put less of an operational burden on the user (operator) when the user performs various registrations on an operator panel of the image formation apparatus.

An object of an embodiment of the invention is to provide an image formation apparatus, an information processing apparatus, and an information processing system which can reduce the operational burden on a user when the user performs various registrations.

An aspect of the invention is an image formation apparatus that includes: a power supply unit that supplies power to the image formation apparatus; a display part on which a screen is to be displayed; and a controller that controls the display on the display part. When the power supply unit is turned on, the controller switches the display on the display part to a first screen for user registration in a situation where the first screen is displayable, and switches the display on the display part to a home screen without switching to the first screen in a situation where the first screen is not displayable.

The above aspect of the invention can reduce the operational burden on a user performing various registrations on the operation panel unit of the image formation apparatus.

### BRIEF DESCRIPTION OF THE DRAWINGS

FIG. 1 is a block diagram schematically illustrating the configurations of an image formation apparatus, an information processing apparatus, and an information processing system according to an embodiment of the invention.

FIGS. 2A to 2D are diagrams illustrating examples of screens displayed on a display part of an operation panel unit when the image formation apparatus according to the embodiment is powered on for the first time.

FIG. 3 is a flowchart illustrating an operation performed by the image formation apparatus when the image formation apparatus according to the embodiment is powered on for the first time.

FIG. 4 is a flowchart illustrating an operation performed by the information processing apparatus when the image formation apparatus according to the embodiment is powered on for the first time or when a product information button is pressed after the second activation of the image formation apparatus.

FIGS. 5A to 5D are diagrams illustrating examples of screens displayed on the display part when the product information button is pressed on a home screen on the display part of the operation panel unit of the image formation apparatus according to the embodiment.

FIG. 6 is a flowchart illustrating an operation performed by the image formation apparatus when the product information button is pressed on the home screen on the display part of the operation panel unit of the image formation apparatus according to the embodiment.

### DETAILED DESCRIPTION OF EMBODIMENTS

Descriptions are provided hereinbelow for embodiments based on the drawings. In the respective drawings referenced herein, the same constituents are designated by the same reference numerals and duplicate explanation concerning the same constituents is omitted. All of the drawings are provided to illustrate the respective examples only.

### 1. Configuration

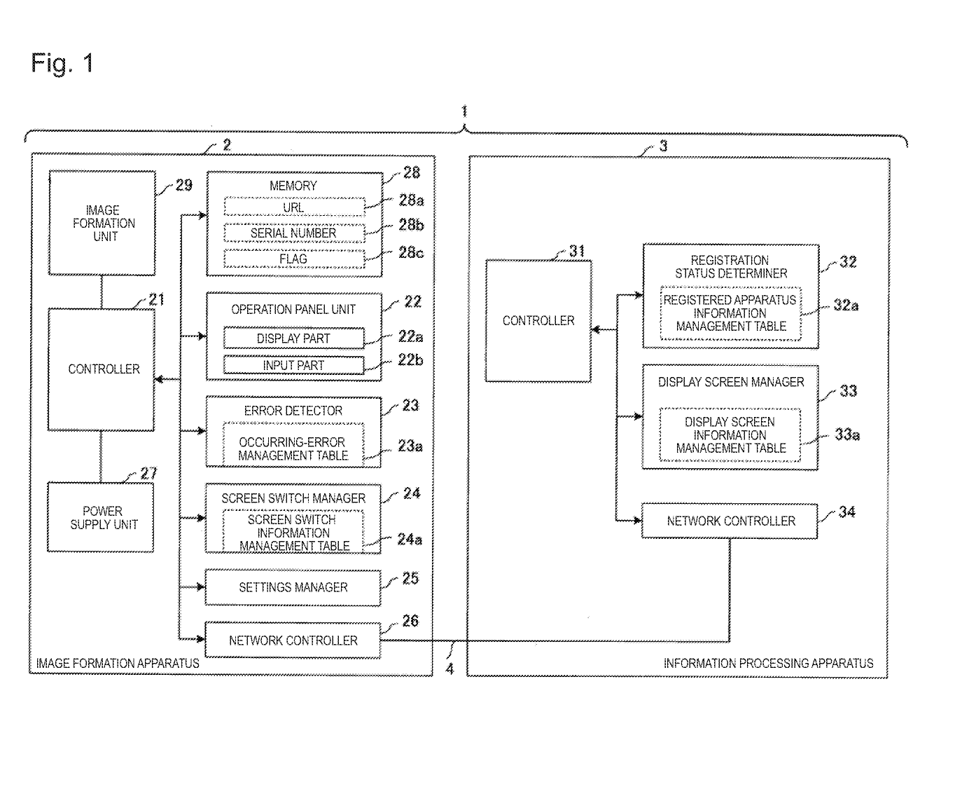

FIG. 1 is a block diagram schematically illustrating the configurations of image formation apparatus 2, information processing apparatus 3, and information processing system 1 according to an embodiment of the invention. As illustrated in FIG. 1, information processing system 1 (e.g., an image processing system) includes image formation apparatus 2 and information processing apparatus 3 which serves as a management server (higher-level apparatus). Image formation apparatus 2 and information processing apparatus 3 are communicatively connected to each other through network 4, such as the Internet. Image formation apparatus 2 is an electronic device such as a printer, a copier, a fax machine, or a multi-purpose machine. Information processing apparatus 3 is, for example, a computer (management server) of the service provider (e.g., the manufacturer) of image formation apparatus 2. Image formation apparatus 2 is capable of printing images on recording media. However, the invention is applicable also to an apparatus (electronic device) without the image formation capability, as long as the apparatus can receive various services through a network. Information processing system 1 is capable of performing an information processing method according to the embodiment of the invention.

Image formation apparatus 2 includes controller 21 (first controller), operation panel unit (operator panel) 22, which is an operation input unit with a display operated by a user (operator), error detector 23, which is a determiner that detects and manages information on an error occurring in image formation apparatus 2 (occurring-error information), screen switch manager 24, settings manager 25, network controller 26 (first network controller) as a communication interface, power supply unit 27, memory 28 as a storage unit that stores information, and image formation unit 29 as a printer unit.

Controller 21 controls operation panel unit 22, error detector 23, screen switch manager 24, settings manager 25, network controller 26, power supply unit 27, memory 28, and image formation unit 29. For example, controller 21 controls the display on operation panel unit 22 (or specifically, display part 22a).

Operation panel unit 22 includes display part 22a on which information is to be displayed and input part 22b that is used to input information. Operation panel unit 22 is, for example, a touch panel. A touch panel is an electronic device combining a display (display part 22a), such as a liquid crystal panel, and a pointing device (input part 22b), such as a touch pad. A user can input his or her request into image formation apparatus 2 by pressing (or touching) a button (or an icon) displayed on display part 22a of operation panel unit 22.

Error detector 23 detects an error occurring in image formation apparatus 2 and retains, in a storage unit therein, occurring-error management table 23a containing error information. When detecting that the occurring error has been resolved, error detector 23 deletes the error information on the resolved error from occurring-error management table 23a. Examples of an occurring error include a situation where network controller 26 of image formation apparatus 2 cannot communicate with information processing apparatus 3 via network 4.

Screen switch manager 24 retains, in a storage unit therein, screen switch information management table 24a containing screen switch information. The screen switch information is information on the switching of screens displayed on display part 22a. Screen switch information management table 24a contains information on a screen to be displayed on display part 22a (a screen to switch to next) according to a screen currently displayed, user input, and the status of image formation apparatus 2 (e.g., error information).

Settings manager 25 retains, in a storage unit in settings manager 25, the settings for image formation apparatus 2 that are configured by the user using input part 22b.

Network controller 26 is, for example, a network interface used to communicatively connect to information processing apparatus 3.

Power supply unit 27 supplies power to image formation apparatus 2. Specifically, power supply unit 27 is a circuit for supplying power to, for example, controller 21, operation panel unit 22, error detector 23, screen switch manager 24, settings manager 25, network controller 26, memory 28, and image formation unit 29, and includes a switch for turning the power of image formation apparatus 2 on and off.

Memory 28 is any type of storage such as a semiconductor storage device or a hard disk drive, and stores information such as a uniform resource locator (URL) 28a, serial number 28b of image formation apparatus 2, and flag 28c.

Image formation unit 29 is a printer unit that forms an image on a sheet serving as a recording medium. For example, image formation unit 29 forms a toner image on a recording medium using electrophotography. Image formation unit 29 may alternatively be a printer unit that uses other printing technology than electrophotography. Image formation unit 29 may be equipped with a scanner as an image reader that optically reads an image on an original and generates image data.

In the above description, memory 28, the storage unit in error detector 23, the storage unit in screen switch manager 24, and the storage unit in settings manager 25 are separate storage units. However, these storage units may be separate storage areas in the same storage device.

In the above description, controller 21, error detector 23, screen switch manager 24, and settings manager 25 have separate configurations. Alternatively, they may be included in a common electronic circuit. In addition, functions of controller 21, error detector 23, screen switch manager 24, and settings manager 25 may be implemented by a processor (information processor) that executes programs stored in a storage unit (e.g., memory 28).

As illustrated in FIG. 1, information processing apparatus 3, as the management server, includes controller 31 (second controller), registration status determiner 32, display screen manager 33, and network controller 34 (second network controller).

Registration status determiner 32 retains, in a storage unit therein, registered apparatus information management table 32a containing registered apparatus information indicating whether user registration has been completed for image formation apparatus 2 (external apparatus), and by searching registered apparatus information management table 32a, determines whether user registration has been completed for image formation apparatus 2, which is an external apparatus that has made a request.

Display screen manager 33 retains and manages, in a storage unit therein, display screen information management table 33a containing information indicating which screen should be displayed by image formation apparatus 2 according to the content of a request from image formation apparatus 2.

Network controller 34 controls communications with external apparatuses. Network controller 34 includes, for example, a network interface used to communicatively connect to image formation apparatus 2.

Controller 31 controls registration status determiner 32, display screen manager 33, and network controller 34. Controller 31, registration status determiner 32, and display screen manager 33 have separate configurations in the above description, but they may be included in a common electrical circuit. The functions of controller 31, registration status determiner 32, and display screen manager 33 may be implemented by a processor which is an information processor that executes programs stored in a memory in information processing apparatus 3. Although the storage unit in registration status determiner 32 and the storage unit in display screen manager 33 are separate storage units in the above description, these storage units may be separate storage areas in the same storage device.

### 2. Operation Performed Upon First Activation

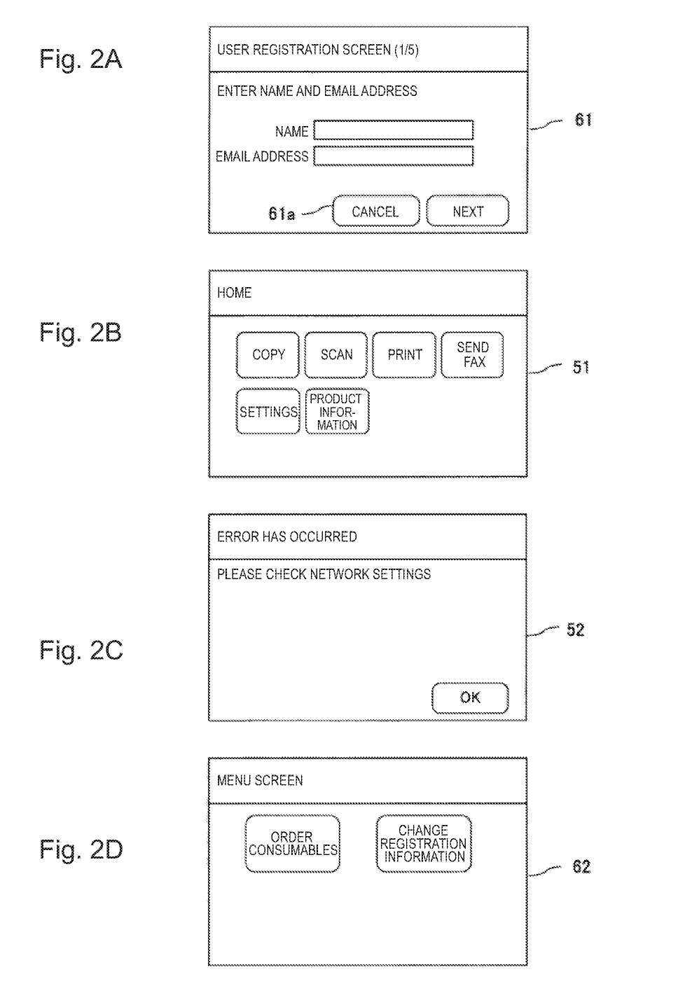

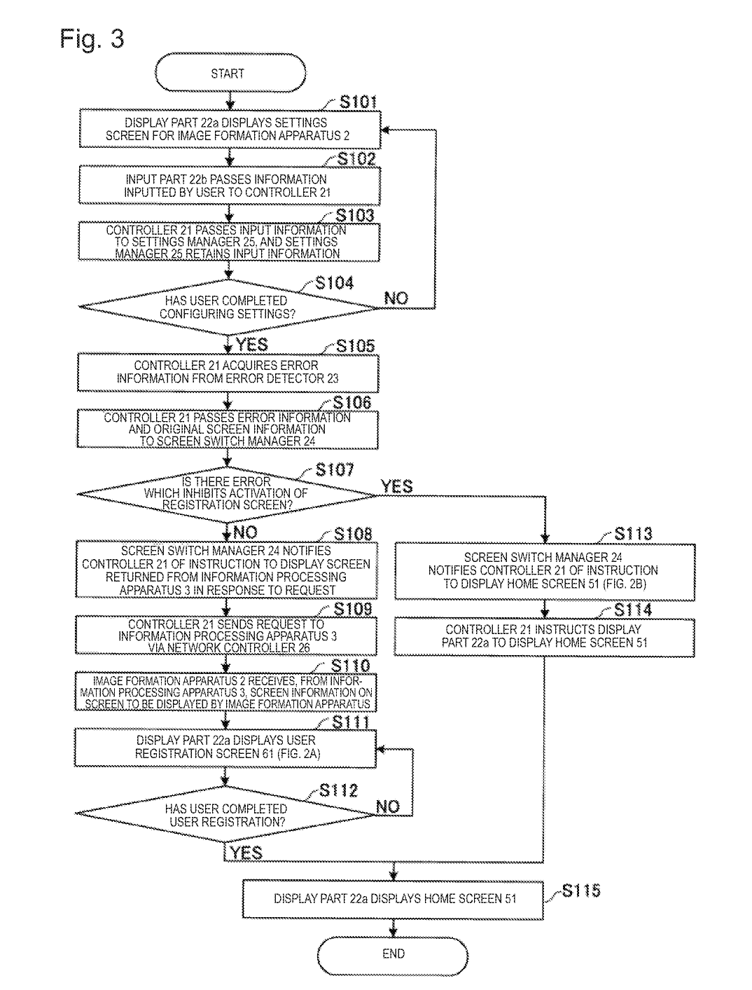

FIGS. 2A to 2D are diagrams illustrating examples of screens displayed on display part 22a of operation panel unit 22 when image formation apparatus 2 is powered on for the first time (first activation). FIG. 3 is a flowchart illustrating the operations performed by image formation apparatus 2 when image formation apparatus 2 is powered on for the first time.

When a user powers on image formation apparatus 2 for the first time, display part 22a of operation panel unit 22 displays a settings screen for the user to configure the settings for image formation apparatus 2 (Step S101). Next, when the user follows instructions on the settings screen and inputs settings using input part 22b, input part 22b detects what has been inputted, and passes the input information to controller 21 (Step S102). Controller 21 passes the input information received from input part 22b to settings manager 25, and settings manager 25 retains the settings received from controller 21 (Step S103). Steps S101 to S103 are repeated until the user completes configuring the settings (i.e., until the determination result in Step S104 is YES). After the first activation, controller 21 stores flag 28c in memory 28 after finishing the processing in Steps S101 to S103 and before proceeding to the determination processing in Step S104. Flag 28c indicates completion of the first activation (the first power-on). Upon the next activation, controller 21 can determine whether the activation is the first activation or not by checking whether flag 28c is stored in memory 28. Thus, when flag 28c is stored in memory 28, controller 21 omits the determination by error detector 23 and switches the display on display part 22a to home screen 51. In other words, when the activation is not the first activation, the flowchart in FIG. 3 is not performed, and display part 22a displays, for example, home screen 51 illustrated in FIG. 2B. Home screen 51 includes buttons (icons) for executing various capabilities of image formation apparatus 2.

When the user completes configuring the settings (YES in Step S104), controller 21 acquires occurring-error information from error detector 23. The occurring-error information is information on an error occurring in image formation apparatus 2 (Step S105). Every time an error occurs in image formation apparatus 2, error detector 23 detects the error and adds error information to occurring-error management table 23a. When an occurring error is resolved, error detector 23 detects the resolution of the occurring error, and deletes the error information on the resolved error from occurring-error management table 23a.

Next, controller 21 passes, to screen switch manager 24, the error information acquired from error detector 23 and the original screen information, which is information on an original screen before screen-switching (the pre-switch screen), in order to inquire about screen information on a screen to be displayed next (Step S106).

In Step S107, screen switch manager 24 searches screen switch information management table 24a to determine whether the error information acquired from controller 21 contains an error which inhibits activation of user registration screen 61 (first screen). When the error information contains no such error (NO in Step S107), screen switch manager 24 notifies controller 21 of an instruction to display a screen returned from information processing apparatus 3 in response to a request (Step S108). The error which inhibits activation of user registration screen 61 is, for example, a situation where image formation apparatus 2 is not communicatively connected to information processing apparatus 3 due to flawed network settings. To gain access to information processing apparatus 3 after the determination result in Step S107 is NO (e.g., when the user presses product information button 51a on home screen 51 in FIG. 2B after the determination result in Step S107 is NO), image formation apparatus 2 adds serial number 28b of itself (registration-target image formation apparatus 2) to URL 28a, used to access to information processing apparatus 3, which is stored in memory 28 in advance.

Upon receiving the information regarding the next screen from screen switch manager 24 in Step S108, controller 21 sends a request (first request) to information processing apparatus 3 through network controller 26 (Step S109). As a response to the request, controller 21 of image formation apparatus 2 receives, from information processing apparatus 3, information on a screen to be displayed by image formation apparatus 2 (e.g., screen information on user registration screen 61) (Step S110). Controller 21 causes display part 22a to display the screen indicated by the screen information received from information processing apparatus 3 (e.g., user registration screen 61 in FIG. 2A) (Step S111). Image formation apparatus 2 may be configured such that, in Steps S107 to S111, when error detector 23 determines that user registration screen 61 can be displayed (e.g., when error detector 23 determines based on the search result obtained by screen switch manager 24 in Step S107 that user registration screen 61 can be displayed), controller 21 sends a first request for user registration to information processing apparatus 3 (Step S109) and switches the display on display part 22a to user registration screen 61.

When the user completes the user registration using input part 22b by following the display screen on display part 22a (YES in Step S112), display part 22a displays home screen 51 (e.g., FIG. 2B) (Step S115). In addition, when the user completes the user registration in Step S112 (YES in Step S112), for example, registration information inputted on user registration screen 61 (FIG. 2A), the serial number of the registration-target apparatus added to URL 28a (e.g., serial number 28b of image formation apparatus 2), and information indicating that the registration target apparatus is registered are associated with one another and stored in registered apparatus information management table 32a.

On the other hand, when it is determined in Step S107 that the error information acquired from controller 21 contains an error which inhibits the activation of user registration screen 61 (YES in Step S107), screen switch manager 24 searches screen switch information management table 24a using the original screen information indicating that the before-switching screen is a screen displayed upon the first activation. Based on a result of the search, screen switch manager 24 notifies controller 21 of an instruction to display home screen 51 by omitting an error notification screen (Step S113) and skipping user registration screen 61 which would have otherwise been displayed. Upon being notified of the instruction to display home screen 51 (e.g., FIG. 2B) by omitting an error notification screen (e.g., FIG. 2C) and skipping user registration screen 61 (e.g., FIG. 2A) which would have otherwise been displayed, controller 21 instructs display part 22a to display home screen 51 (Step S114), and display part 22a displays home screen 51 (Step S115). Image formation apparatus 2 may be configured such that, in Steps S107, S113, and S114, when error detector 23 determines that user registration screen 61 cannot be displayed (e.g., when error detector 23 determines, based on the search result obtained by screen switch manager 24 in Step S107, that user registration screen 61 cannot be displayed), controller 21 switches display part 22a not to user registration screen 61 but to home screen 51.

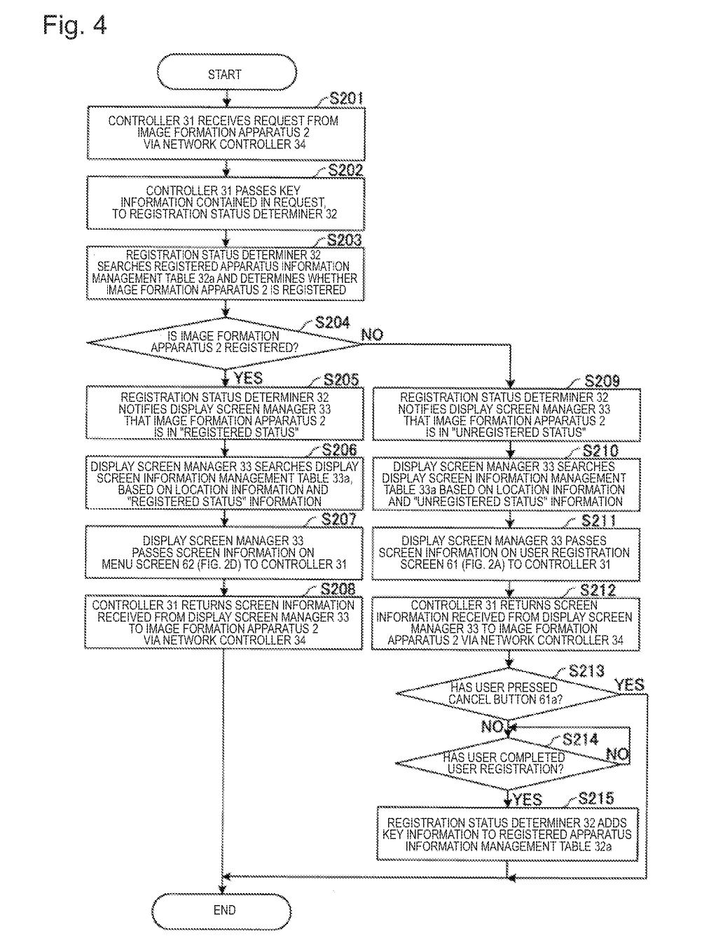

FIG. 4 is a flowchart illustrating the operations performed by information processing apparatus 3 when image formation apparatus 2 is powered on for the first time (e.g., when receiving the request sent from image formation apparatus 2 in Step S109 after the determination result in Step S107 is NO), or when the user presses product information button 51a after the second activation of image formation apparatus 2. First, controller 31 of information processing apparatus 3 receives the request from image formation apparatus 2 via network controller 34 (Step S201). The request from image formation apparatus 2 typically contains key information (such as serial number 28b of image formation apparatus 2) used to determine whether image formation apparatus 2 is registered and location information (such as URL 28a) indicating a storage location of information on a screen to be displayed. Controller 31 passes the key information contained in the request to registration status determiner 32 (Step S202). Registration status determiner 32 searches registered apparatus information management table 32a stored in the storage unit in registration status determiner 32 by using the received key information, and determines whether image formation apparatus 2 that has sent the request (search target image formation apparatus) is registered in registered apparatus information management table 32a (Step S203).

When it is determined in Step S204 that image formation apparatus 2 is registered (i.e., when user registration is completed for image formation apparatus 2) (YES in Step S204), registration status determiner 32 notifies display screen manager 33 of information indicating that image formation apparatus 2 is registered (Step S205). Display screen manager 33 searches display screen information management table 33a by using the information it was notified of by registration status determiner 32 and the location information (Step S206). As a result of the search, display screen manager 33 notifies controller 31 of the information on menu screen 62 (FIG. 2D), which is a second screen (e.g., screen information on menu screen 62) (Step S207). Controller 31 sends the screen information it was notified of by display screen manager 33 (e.g., the screen information on menu screen 62 to be displayed by image formation apparatus 2) to image formation apparatus 2 via network controller 34 (Step S208). As illustrated in FIG. 2D, menu screen 62 includes, for example, at least one of a screen for ordering consumables used with image formation apparatus 2 and a screen for changing user registration information on image formation apparatus 2.

When it is determined in Step S204 that image formation apparatus 2 is not registered (i.e., user registration is not completed for image formation apparatus 2) (NO in Step S204), registration status determiner 32 notifies display screen manager 33 of the information indicating that image formation apparatus 2 is not registered (Step S209). Display screen manager 33 searches display screen information management table 33a by using the information it was notified of by registration status determiner 32 and the location information (Step S210). As a result of the search, display screen manager 33 notifies controller 31 of the information on user registration screen 61 (FIG. 2A) (Step S211). Information processing apparatus 3 (or specifically, controller 31) sends the screen information it was notified of by display screen manager 33 (e.g., the screen information on user registration screen 61 to be displayed by image formation apparatus 2) to image formation apparatus 2 via network controller 34 (Step S212).

When the user selects cancel button (icon) 61a on user registration screen 61 (e.g., FIG. 2A) (YES in Step S213), information processing apparatus 3 ends the processing. On the image formation apparatus 2 end, display part 22a switches from user registration screen 61 in FIG. 2A to home screen 51 in FIG. 2B.

When the user does not select cancel button 61a and completes the user registration on user registration screen 61 (FIG. 2A) on display part 22a of operation panel unit 22 of image formation apparatus 2 (YES in Step S214), registration status determiner 32 of information processing apparatus 3 adds key information, such as serial number 28b, of image formation apparatus 2 to registered apparatus information management table 32a (Step S215).

3. Operation Performed when Product Information Button is Pressed

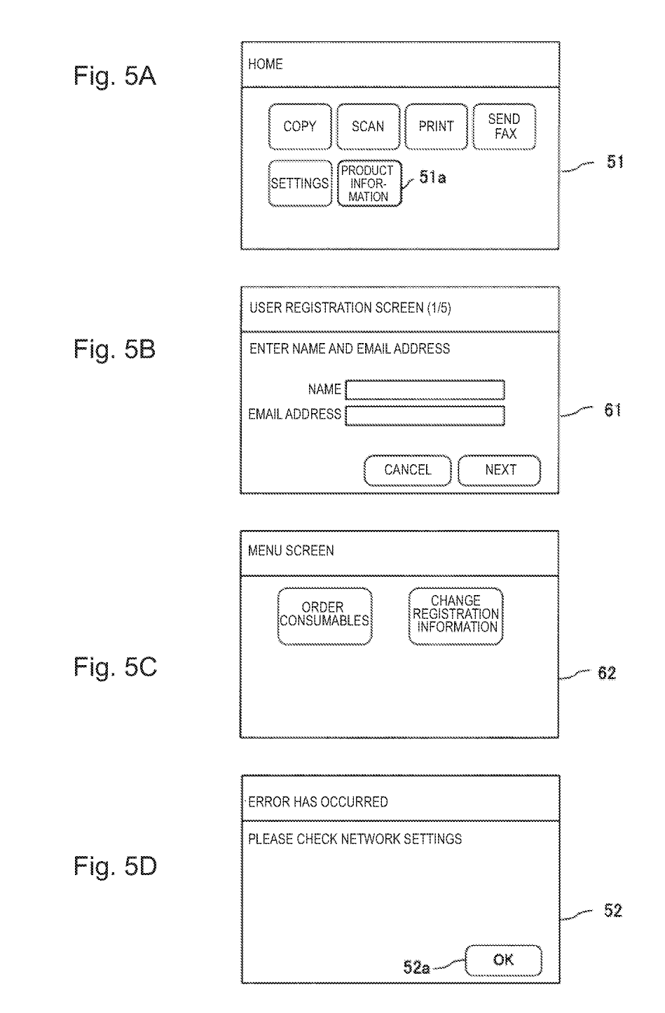

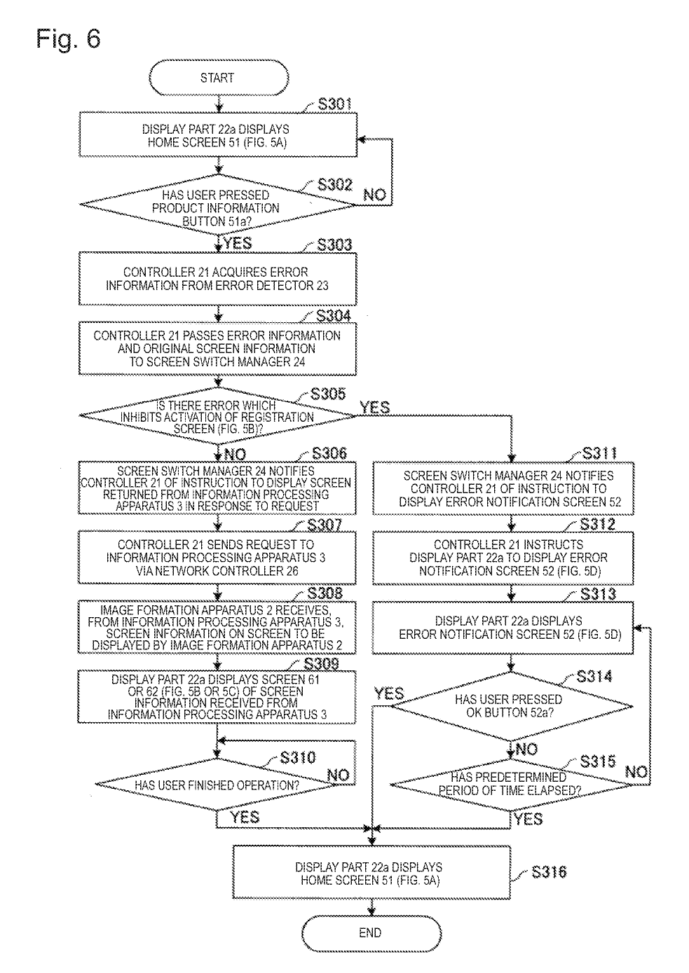

FIGS. 5A to 5D illustrate examples of screens displayed when product information button 51a is pressed on home screen 51 on display part 22a of operation panel unit 22 of image formation apparatus 2. FIG. 6 is a flowchart illustrating the operations performed by image formation apparatus 2 when product information button 51a is pressed on home screen 51 on display part 22a of operation panel unit 22 of image formation apparatus 2.

First, display part 22a displays home screen 51 (FIG. 5A) (Step S301). Home screen 51 (FIG. 5A) has product information button 51a, which is an icon for displaying a product information screen (e.g., user registration screen 61). Product information button 51a is allocated with the same location information and key information as the ones contained in the request sent to information processing apparatus 3 at the first activation of image formation apparatus 2 (Step S109). When the user presses product information button 51a, a request containing the location information and the key information is sent to information processing apparatus 3.

When the user presses product information button 51a (YES in Step S302), controller 21 acquires, from error detector 23, error information on an error currently occurring in image formation apparatus 2 (Step S303). Next, controller 21 passes the error information acquired from error detector 23 and the information on the pre-switch screen (original screen information) to screen switch manager 24 to inquire about information on a screen to be displayed (Step S304).

When the error information acquired from controller 21 does not contain an error which inhibits activation of user registration screen 61 (FIG. 5B) (NO in Step S305), screen switch manager 24 returns, to controller 21, an instruction to display a screen returned from information processing apparatus 3 in response to a request (Step S306). As with the case for the first activation, the error which inhibits activation of user registration screen 61 is, for example, a situation where image formation apparatus 2 cannot be connected to information processing apparatus 3 due to flawed network settings.

Controller 21 sends a request (second request) to information processing apparatus 3 via network controller 26 (Step S307). Image formation apparatus 2 may be configured such that when the error detector determines in Steps S303 to S305 based on the error information that user registration screen 61 can be displayed, controller 21 sends the second request (e.g., a request for user registration) to information processing apparatus 3 in Steps S306 to S307.

As a response to the request, controller 21 of image formation apparatus 2 receives, from information processing apparatus 3, information on a screen to be displayed by image formation apparatus 2 (Step S308).

Display part 22a displays the screen indicated by the screen information received by controller 21 from information processing apparatus 3 (Step S309). The screen information received from information processing apparatus 3 is different depending on whether the user registration for image formation apparatus 2 is completed. When the user registration is completed, image formation apparatus 2 displays menu screen 62 (FIG. 5C), which is the second screen, on display part 22a. In other words, controller 21 of image formation apparatus 2 causes display part 22a to display menu screen 62. More specifically, when the user selects product information button 51a (YES in Step S302) and if the user registration is completed, controller 21 switches the display on display part 22a not to user registration screen 61, but to menu screen 62 (Step S309). If the user registration is not completed, on the other hand, image formation apparatus 2 displays user registration screen 61 (FIG. 5B), which is the first screen, on display part 22a. In other words, controller 21 of image formation apparatus 2 causes display part 22a to display user registration screen 61. More specifically, when the user selects product information button 51a (YES in Step S302) and if the user registration is not completed, controller 21 switches the display on display part 22a to user registration screen 61 (Step S309).

When the user finishes the operation (YES in Step S310), display part 22a displays home screen 51 (FIG. 5A) (Step S316).

When it is determined in Step S305 that the error information acquired from controller 21 contains an error which inhibits the activation of user registration screen 61 (FIG. 5B) (YES in Step S305), screen switch manager 24 searches screen switch information management table 24a based on the information indicating that the before-switching screen is home screen 51 (FIG. 5A), and as a result of the search, returns, to controller 21, an instruction to display error notification screen 52 (Step S311). Upon receiving the instruction from screen switch manager 24, controller 21 issues a command to display error notification screen 52 to display part 22a (Step S312), and display part 22a displays error notification screen 52 (FIG. 5D) (Step S313). In other words, controller 21 causes display part 22a to display error notification screen 52. Image formation apparatus 2 may be configured such that, when the user selects product information button 51a (YES in Step S302) and when error detector 23 determines that user registration screen 61 cannot be displayed (e.g., when error detector 23 determines based on the search result obtained by screen switch manager 24 in Step S311 that user registration screen 61 cannot be displayed), controller 21 switches the display on display part 22a to error notification screen 52 in Steps S311 to S313.

Error notification screen 52 has OK button 52a, which is a button (icon) for closing error notification screen 52. When the user presses OK button 52a (YES in Step S314), display part 22a displays home screen 51 (FIG. 5A) (Step S316). Even when the user does not press OK button 52a in Step S314 (NO in Step S314), display part 22a displays home screen 51 (FIG. 5A) (Step S316) when a certain period of time elapses after display part 22a starts displaying error notification screen 52 (YES in Step S315).

### 4. Advantageous Effects

As described above, with the use of image formation apparatus 2, information processing apparatus 3, and information processing system 1 according to the present embodiment, even when an error which inhibits activation of user registration screen 61 is occurring at the time of the first activation of image formation apparatus 2, image formation apparatus 2 does not generate an error notification such as the one illustrated in FIG. 2C, skips user registration screen 61, and displays home screen 51 (Steps 107, S113 to S115). This enables the user of image formation apparatus 2 to have image formation apparatus 2 perform a task that the user wants (e.g., copying, scanning, printing, or sending a facsimile), without having to perform the bothersome operation of having to cancel the error notification displayed on display part 22a.

In addition, with the use of image formation apparatus 2, information processing apparatus 3, and information processing system 1, when an error which inhibits activation of user registration screen 61 is not occurring at the time of the first activation of image formation apparatus 2, display part 22a of image formation apparatus 2 displays user registration screen 61, and after completion of the user registration, displays home screen 51 (Steps S107 to S112 and S115). Thus, a user of image formation apparatus 2 can have image formation apparatus 2 perform the desired operation (e.g., copying, scanning, printing, or sending a facsimile).

When a user presses product information button 51a on home screen 51 in the situation where an error which inhibits activation of user registration screen 61 is not occurring, a different screen (e.g., FIG. 5B or FIG. 5C) is displayed depending on the user registration status of image formation apparatus 2. This enables the efficient provision of a screen needed by the user (Steps S305 to S310 and S316).

When a user presses product information button 51a on home screen 51 in the situation where an error which inhibits activation of user registration screen 61 is occurring, display part 22a of image formation apparatus 2 displays error notification screen 52 to notify the user that an error is occurring (Steps S305 and S311 to S316). When a user presses product information button 51a on home screen 51, the user hopes to communicate with information processing apparatus 3 as the management server. Thus, unlike the case with the first activation of image formation apparatus 2 where it is unknown whether the user wants user registration processing, the user is not bothered by the error notification screen. Moreover, the error notification screen displayed is switched to the home screen when the user presses the cancel button (Step S314) or when a certain period of time elapses (Step S315). Thus, the user should not be bothered by the error notification screen.

### 5. Modifications

In the above description, when an error which inhibits activation of user registration screen 61 is occurring at the time of the first activation of image formation apparatus 2, display part 22a displays home screen 51 by omitting error notification screen 52 and skipping user registration screen 61. Alternatively, whether error notification screen 52 is displayed may be determined according to the type of error which inhibits activation of user registration screen 61.

When display part 22a is switched to home screen 51 by omitting error notification screen 52, the product information button (51a in FIG. 5A) for activating user registration screen 61 may be located at a position easily viewable by the user or may be emphasized so that the user can recognize the button easily.

Additionally, image formation apparatus 2 may emphasize the product information button (51a in FIG. 5A) for activating user registration screen 61 when an error which inhibits activation of user registration screen 61 is resolved.

The invention includes other embodiments in addition to the above-described embodiments without departing from the spirit of the invention. The embodiments are to be considered in all respects as illustrative, and not restrictive. The scope of the invention is indicated by the appended claims rather than by the foregoing description. Hence, all configurations including the meaning and range within equivalent arrangements of the claims are intended to be embraced in the invention.

1. An image formation apparatus comprising:
a power supply unit that supplies power to the image formation apparatus;
a display part on which a screen is to be displayed; and
a controller that controls a display on the display part, wherein
when the power supply unit is turned on, the controller switches the display on the display part to a first screen for user registration in a situation where the first screen is displayable, and switches the display on the display part to a home screen without switching to the first screen in a situation where the first screen is not displayable.

2. The image formation apparatus according to claim 1, wherein
the home screen includes an icon which is selected to display the first screen, and
when the icon is selected and the user registration have been completed, the controller switches the display on the display part to a second screen which is different from the first screen.

3. The image formation apparatus according to claim 2, wherein
when the icon on the home screen is selected in a situation where the first screen is not displayable, the controller switches the display on the display part to an error notification screen.

4. The image formation apparatus according to claim 1, further comprising:
a determiner that determines whether the first screen for user registration is displayable on the display part, the determination being made after the power supply is turned on and before the display on the display part is switched to the home screen; and
a memory that stores information, wherein
when the power supply unit is turned on for a first time, the controller stores, in the memory, a flag indicating that the image formation apparatus has been powered on for the first time, and
when the flag is stored in the memory, the controller switches the display on the display part to the home screen by omitting the determination by the determiner.

5. The image formation apparatus according to claim 2, wherein
the second screen includes at least one of a screen used to order consumables and a screen used to change user registration information.

6. An information processing system including an image formation apparatus and an information processing apparatus capable of communicating with the image formation apparatus, wherein
the image formation apparatus comprises
a power supply unit that supplies power to the image formation apparatus,
a display part on which a screen is to be displayed, and
a controller that controls a display on the display part, wherein
when the power supply unit is turned on in a situation where a first screen for user registration is displayable, the controller sends a first request for user registration to the information processing apparatus,
when the user registration is not completed for the image formation apparatus which has sent the first request, the information processing apparatus sends first screen information, which is information about the first screen, to the image formation apparatus which has sent the first request, and
upon receiving the first screen information, the controller of the image formation apparatus causes the display part to display the first screen based on the first screen information.

7. The information processing system according to claim 6, wherein
when the user registration is completed for the image formation apparatus which has sent the first request, the information processing apparatus which has received the first request sends second screen information, which is information about a second screen different from the first screen, to the image formation apparatus which has sent the first request, and
upon receiving the second screen information, the controller of the image formation apparatus causes the display part to display the second screen.

8. The information processing system according to claim 7, wherein
a home screen includes an icon which is selected to display the first screen,
when the icon is selected in a situation where the first screen is displayable, the controller sends a second request for user registration to the information processing apparatus,
when the user registration is not completed for the image formation apparatus which has sent the second request, the information processing apparatus sends the first screen information to the image formation apparatus which has sent the second request, and
upon receiving the first screen information, the controller of the image formation apparatus causes the display part to display the first screen.

9. The information processing system according to claim 8, wherein
when the user registration is completed for the image formation apparatus which has sent the second request, the information processing apparatus sends the second screen information to the image formation apparatus which has sent the second request, and
upon receiving the second screen information, the controller of the image formation apparatus causes the display part to display the second screen.

10. The information processing system according to claim 8, wherein
when the icon is selected in a situation where the first screen is not displayable, the controller causes the display part to display an error notification screen.

11. An information processing apparatus communicatively connected to an external apparatus, the information processing apparatus comprising:
a registration status determiner that retains a registered apparatus information management table containing registered apparatus information indicating whether a user registration is completed for the external apparatus;
a display screen manager that retains, as a screen information management table, information indicating which screen is to be displayed by the external apparatus according to a content of a request for the user registration sent from the external apparatus, and
a controller that controls the registration status determiner and the display screen manager.

12. The information processing apparatus according to claim 11, wherein
the registration status determiner determines whether the external apparatus which has sent the request is registered in the registered apparatus information management table, and notifies the display screen manager of a result of the determination,
based on the result of the determination notified of by the registration status determiner, the display screen manager notifies the controller of screen information on a screen to be displayed by the external apparatus, and
the controller sends the external apparatus the screen information notified of by the display screen manager.
